(19) United States
(12) Patent Application Publication
(10) Pub. No.: US 2009/0205382 A1
(43) Pub. Date: Aug. 20, 2009

(54) DEVICE FOR CONTROLLING A CONDITION OF AN EXIT DEVICE ON A DOOR

(76) Inventors: Steven R. Kem, Cornelius, OR (US); David P. Kelley, Tigard, OR (US)

Correspondence Address: GANZ LAW, P.C., P O BOX 2200, HILLSBORO, OR, 97123, US

(21) Appl. No.: 12/371,520

(22) Filed: Feb. 13, 2009

Related U.S. Application Data
(60) Provisional application No. 61/029,898, filed on Feb. 19, 2008.

(51) Int. Cl. E05B 65/06; B25B 27/14

(52) U.S. Cl. 70/93; 29/281.6

(57) ABSTRACT

A lock-out device for an exit device door operator mechanism, the lock-out device being configured to interact with the operator mechanism, which would normally require a key to change the condition of the operator mechanism between a locked and unlocked condition, thereby allowing someone on the inside of the door to manually lock the door against entry from the exterior without using the key for the locking mechanism. In one possible embodiment, the lock-out device is adjustable to fit a range of differently sized exit device door operator mechanisms.

### RELATED APPLICATIONS

This application claims priority to and the benefit of U.S. provisional application No. 61/029,898, filed Feb. 19, 2008, entitled DEVICE FOR CONTROLLING A CONDITION OF AN EXIT DEVICE ON A DOOR, the content of which is hereby incorporated by reference as if recited in full herein for all purposes.

### BACKGROUND

The inventive subject matter described herein relates to devices for manually controlling access from a door or other such entry port.

In many facilities, such as schools and workplaces, there are doors equipped with exit devices that are mounted on the inside face of a door and allow the door to be opened when a body pushes or presses against the device, free of hand contact. In such facilities, the doors are typically unlocked during hours of use and locked after hours. Typically a custodian of the facility walks door-to-door manually locking or unlocking each door with a key. Unfortunately the requirement of these systems is that if a security situation (e.g., a gunman) arises on a campus during hours of use, when doors are unlocked, the operator may not be able to go door-to-door as quickly as the security situation dictates.

Some devices have been developed to control access from the inside on exit devices of a door. However, none of the prior art designs provides the desired safety features, versatility of use, and ease of operation and placement.

Therefore there is a need for devices to allow occupants of a particular space to immediately respond to a security situation by manually locking doors by themselves without needing to wait for anyone else to come along with the key normally needed to lock down the doors.

### SUMMARY

The inventive subject matter disclosed herein overcomes the problem with existing door operator mechanisms by providing a lock-out device that overrides a normal condition, i.e., the door locking condition of the exit device mechanism. The lock-out device is configured to interact with the mechanism, which would typically require a key for a lock-down, and allows someone on the inside of the doorway to lock the door against entry from the exterior side, without the normal key for locking the mechanism.

According to one possible embodiment, the lock-out device includes a piece of hardware configured to interact with the exit device door operator mechanism, thereby allowing someone on the inside of the door to manually lock the door against entry from the exterior without using the key for the locking mechanism. The lock-out device further includes a receiver for mounting on a door and for receiving a portion of the lock-out device, enabling the lock-out device to hold the operator mechanism of the door in an unlocked condition. The lock-out device may be adjustable to fit a range of differently sized exit device door operator mechanisms. In the foregoing embodiment, the receiver may adjustable allowing the lock-out device to fit a range of differently sized exit door operator mechanisms. In the foregoing embodiment, the adjustable fit may be provided via at least one piece of material, such as a metal shim, adapted to fit between the receiver and inside surface of the door so that the receiver will hold the piece of hardware keeping the operator mechanism of the door in an unlocked condition. In the foregoing embodiment, the lock-out device may engage and hold a push bar assembly in a compressed position. Removal of the lock-out device allows the push bar assembly to be uncompressed, causing a door strike to engage its recess, locking the door. In the foregoing embodiment, the lock-out device may include at least one shim to built-up the receiver so that the lock-out device will hold the push bar assembly in a compressed position. In the foregoing embodiment, the lock-out device may be configured to maintain a bar handle, such as a hinging bar handle, in a depressed position, and removal of the lock-out device allows the door to return to an outward position that causes a door strike to engage its recess, locking the door. In the foregoing embodiment, the adjustable fit may be provided via two or more shims mounted on the receiver so that a slot is created between the shims that will hold a portion of the lock-out device.

In another possible embodiment, a lock-out device may include an attachment element, the attachment element coupleable to a non-engaging portion of the door or operator mechanism; an interactive element, the interactive element adapted to hold the operator mechanism in the unlocked condition; and a hinge connecting the attachment element with the interactive element. The hinge allows the interactive element to change from a first position in which the interactive element is disengaged from the operator mechanism, to a second position in which the interactive element engages the operator mechanism and keeps the door operator mechanism in unlocked condition. In the foregoing embodiment, the lock-out device may further include an adjustment mechanism allowing the lock-out device to adjust to a range of differently sized door operator mechanisms. For example, the adjustment mechanism may include at least two plates that are adjustable relative to each other so that in the second position the interactive element holds the operator mechanism in the unlocked condition. In the foregoing embodiment, the plates may be adjustable over an adjustment range to accommodate different sizes of push bar assemblies. In any of the foregoing embodiments, the lock-out device may include a handle.

In another possible embodiment, the lock-out device may include an exit door device, in a kit with the lock-out device. In another possible embodiment, the lock-out device may include an exit door device, in a kit with the lock-out device. In another possible embodiment, the lock-out device may further include at least two shims in a kit with the lock-out device. In some embodiments, the exit door device may be a compressable bar handle. In other embodiments, the exit door device may be a hingeable bar handle.

The inventive subject matter further contemplates a method of installing lock-out devices on exit device door operator mechanisms in an establishment consisting of a building or complex of buildings having multiple doors provided with exit door operator mechanisms, the operator mechanism normally requiring a key to change the condition of the operator mechanism between a locked and unlocked condition, the method including configuring a piece of hardware to interact with the exit device door operator mechanism, thereby allowing someone on the inside of the door to manually lock the door against entry from the exterior without using the key for the locking mechanism; mounting a receiver on a door for receiving a portion of the lock-out device, enabling the lock-out device to hold the operator mechanism of the door in an unlocked condition; and adjusting the lock-out device to fit a range of differently sized exit device door operator mechanisms.

This and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing as prior art.

FIG. 1A shows a cross sectional view of a door lock-out device mounted on a push-bar exit device of a door.

FIG. 1B shows a perspective view of the door lock-out device of FIG. 1A.

FIG. 1C shows a perspective view of a receiver component for a door lock-out device, wherein the receiver is built-up with one or more shims.

FIG. 2A shows a perspective view of a door and a door lock-out device as it is used on a hinging-bar type exit device.

FIG. 2B shows a perspective view of a lock-out device as used in FIG. 2A.

FIG. 2C shows a perspective view of a receiver built up with a set of shims for the door lock-out device of FIG. 2A.

FIG. 3A shows a perspective view of a door and another embodiment of a door lock-out device as it is used on exit device push bar.

FIG. 3B shows a perspective view of a lock-out device as used in FIG. 3A.

FIGS. 4-8 show a lock-out device according to the prior art.

FIG. 9A shows a perspective view of a lock-out device in an open position.

FIG. 9B shows a perspective view of the lock-out device of FIG.9A in a closed position.

FIG. 10A shows a perspective view of another embodiment of a lock-out device in an open position.

FIG. 10B shows a perspective view of the lock-out device of FIG. 10A in a closed position.

FIG. 11A shows a perspective view of a door with another embodiment of a lock-out device mounted on an exit device push bar.

FIG. 11B shows a perspective view of a door with another embodiment of a lock-out device mounted on an exit device push bar in a closed position.

### DETAILED DESCRIPTION

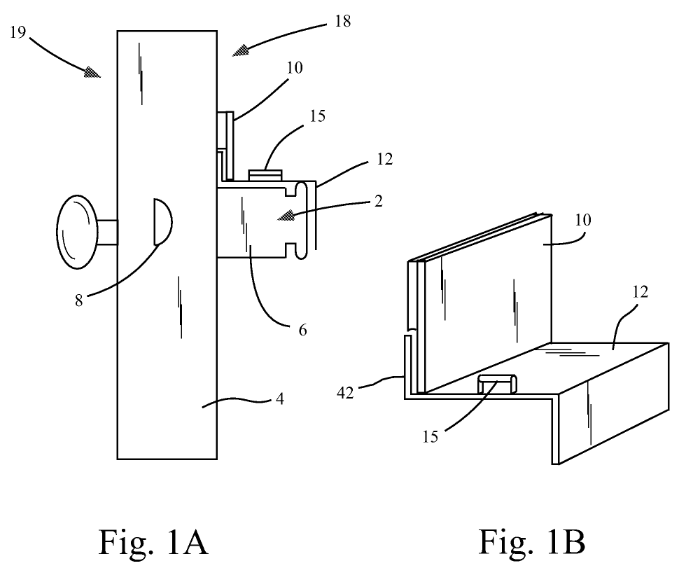

Representative embodiments according to the inventive subject matter are shown in FIGS. 1A-3B and 9A-11B, wherein the same or generally similar features share common reference numerals.

The inventive subject matter is directed to devices for manually controlling access from a door or other such entry port. Examples of such commercially available exit devices are illustrated in the Figures. In particular, the inventive subject matter is directed to a lock-out device for an exit device door operator mechanism, the operator mechanism normally requiring a key to change the condition of the operator mechanism between a locked and unlocked condition. As used herein “key” refers to a traditional key or a tool, such as a hex wrench, that is used to change the condition of an exit device door operator mechanism.

The lock-out device includes a piece of hardware configured to interact with the exit device door operator mechanism, thereby allowing someone on the inside of the door to manually lock the door against entry from the exterior without using the key for the locking mechanism. The lock-out device further includes a receiver for mounting on a door or operator mechanism. The receiver receives a portion of the lock-out device, enabling the lock-out device to hold the operator mechanism of the door in an unlocked condition. The lock-out device is adjustable to fit a range of differently sized exit device door operator mechanisms. The adjustability feature may be, for example, accomplished by a receiver having adjustable dimensions or by providing a separate adjustment mechanism to the lock-out device. In one possible embodiment, the lock-out device may be provided with one or more pieces of material, such as shims, that are adapted to fit between the receiver and inside surface of the doors. In other embodiments, described below, the adjustment mechanism uses overlapping plates that are adjustable over a range to accommodated different sizes of door operator mechanisms.

The term “shim” refers to a thin piece of material, such as metal, wood, etc., to fill up a space. A shim is placed between two parts to make a fit, for example, as described below, between a receiver of the lock-out device and the inside surface of a door to fit the lock-out device against a push bar assembly.

FIGS. 1A-C show one possible embodiment of the subject matter, as it is used on a door 4 having an outside door surface 19, an inside door surface 18, and provided with an exit device 2 mounted on the inside surface 18 of door 4. The exit device 2 is the hardware that operates door 4 from the inside. Exit device 2 includes an operator mechanism, such as an elongate push bar assembly 6 that when compressed slideably retracts strike 8 of door 4 from its recess in the door well. In this embodiment, a piece of hardware, such as a lock-out device 12, is configured to interact with the operator mechanism 6. The lock-out device may be a single piece of hardware or a combination of pieces of hardware that provide the functionalities of a single-piece lock-out device. In some embodiments the lock-out device includes a receiver 10 for receiving a portion of the lock-out device. In the type of lock-out device shown in FIGS. 1A-C, a receiver 10 for lock-out device 12 is mounted on the door 4 just above exit device 2. The lock-out device 12 is slid in place over a push bar assembly 6 in its compressed, open position, which holds the exit device 2 in the open position. In this system it is no longer necessary to use a key to set the door in a default, unlocked condition when occupants are in the room. Instead the exit device 2, when it has a lock-out device 12 on, is set in a default locked position wherein the lock-out device 12 compresses the push bar assembly 6, preventing the retractable strike 8 of door 4 from engaging its recess in the door well. To lock door 4, a room occupant simply removes lock-out device 12 from between the operator and receiver 10, causing the push bar 6 to uncompress and door strike 8 to engage its recess, locking door 4 from exterior entry.

The lock-out device may have a handle at a location that allows for convenient handling of the device. The handle may have any suitable shape, for example a rod mounted directly on a flat surface of the lock-out device. For example, removal of the lock-out device 12 from the push bar and receiver may be facilitated by handle 15.

The lock-out device may be adapted to fit a range of differently sized bars by providing the receiver with shims. For example, FIG. 1C illustrates how receiver 10 may be built-up with a shim 40 to increase the distance from the door 4, and to accommodate receiving a portion 42 of the lock-out device 12. Shim 40 may be attached to the receiver and/or door by any suitable fasteners, for example, fasteners that fit through alignment holes 17. If shimming is needed, a single shim may be used or several separate shim plates may be mounted between the door and the outer plate of the receiver to adapt the lock-out device to an existing exit door operator mechanism. In one possible embodiment, a lock-out device may have dimensions that correspond to a receiver having a length of 3 inches, height of 2^{1/4} inches, and depth of ⅛ inch. Such a receiver may be provided with a shim having a length of 3 inches, height of 1 inch, and width of ⅛ inch, attached to a part of the receiver that accommodates a similarly dimensioned door lock-out device.

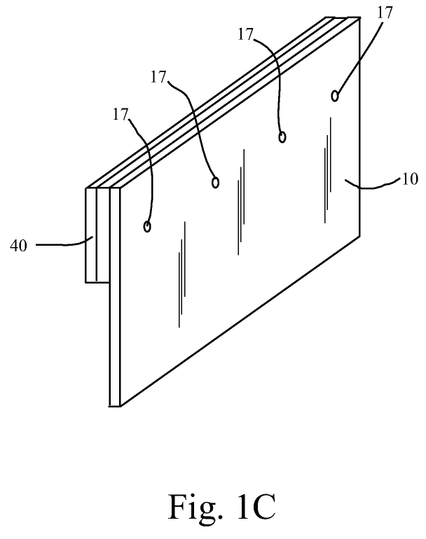

FIGS. 2A-C show another possible embodiment of the inventive subject matter. In this embodiment, the lock-out device 20 works with another common door exit device, such as a hinging-bar type exit device 14. In this embodiment the bar mechanism 14 works by pressing a bar component 16 hingingly towards the inside door surface 18. A generally U or C-shaped lock-out device 20 has one end that fits into a receiver 22 mounted on door 4 and another end that fits over the bar 16, holding the bar in the pressed-in, open position. Removing the lock-out device 20 from the receiver 22 and bar handle 16 causes bar handle 16 to release outwardly, and door strike 8 to engage the recess in the door well, thereby locking door 4. To facilitate placement and removal of lock-out device 20, the device may be provided with a handle 25, such as a ½ inch rod mounted on lock-out device 20, for example in a position as shown in FIG. 2B.

FIG. 2C illustrates how receiver 22 may be formed by building-up a receiver plate 55 with shims. Here, smaller shims 50, 51, 52, and 53, are mounted on a door facing side of a receiving plate 55, leaving a slot B in the middle section of the receiver 22 to hold a portion of the lock-out device 20. The shims may be attached to the receiver plate 55 and door 4 by any suitable fasteners, for example, fasteners used in combination with alignment holes 57. In one possible embodiment the dimensions for the receiver may be a length of 6 inches, a height of 2 inches, and a width of ⅛ inch, and shims with a length of 1 inch, height of 2 inches, and width of ⅛ inch, positioned along both sides of the receiver leaving a 4 inch slot in the middle, and mounted to accommodate a lock-out device.

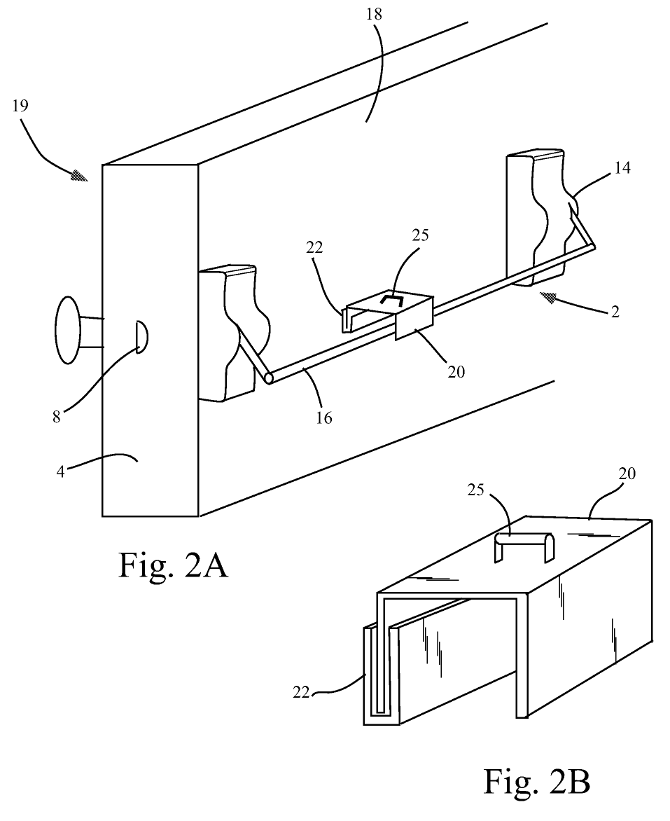

FIGS. 3A-B show another possible embodiment of the inventive subject matter, as it is used with an exit device similar to that shown in FIGS. 1A-C. The device 12 shown in FIGS. 1A-B is flush mounted on door 4. There is no gap between door 4 and elongated push bar assembly 6. Therefore, receiver 10 for lock-out device 12 is required to be mounted on door surface 18. In contrast, in the embodiment of FIGS. 3A-B, elongated bar assembly 26 is not mounted flush to door 4 and a gap 28 is left between bar assembly 26 and door 4. This type of mounting is used on glass doors, for example. Gap 28 allows using a lock-out device that does not need a receiver mounted on the door. Lock-out device 30 is configured to fit over push bar 26 in its compressed condition and retains that condition. Removal of lock-out device 30 uncompresses push-bar assembly 26, allowing for door strike 8 to engage the recess of the door well, locking door 4. Here also, a handle 35 may assist in removing lock-out device 30 from push-bar assembly 26.

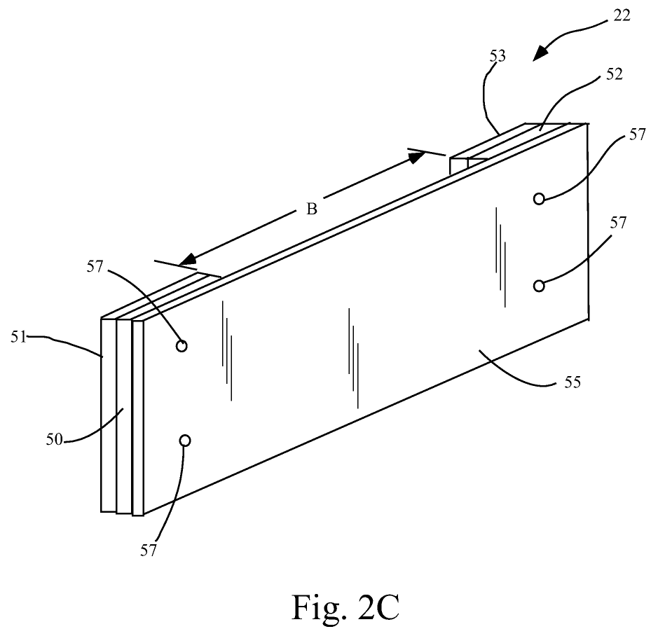

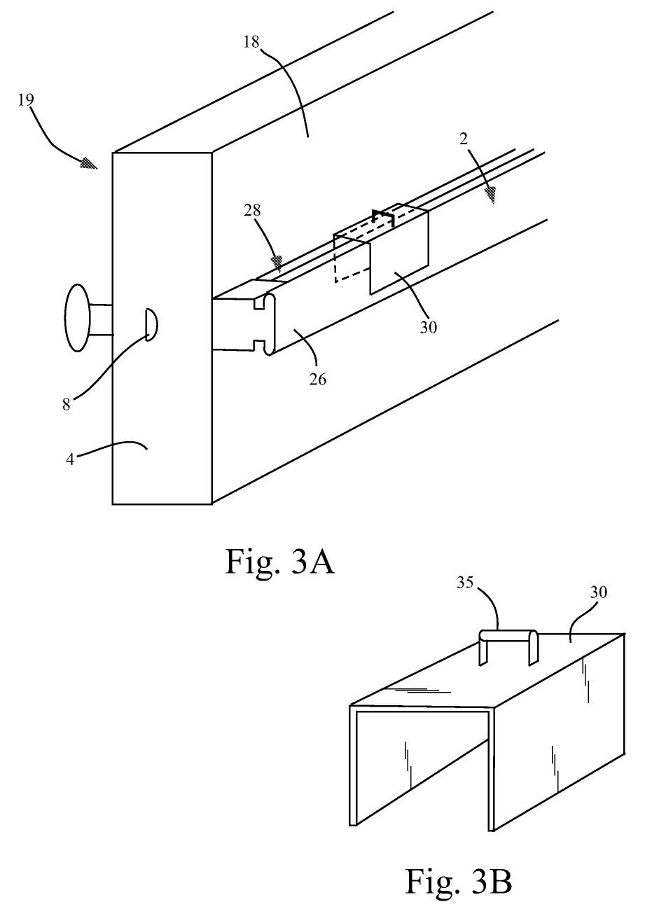

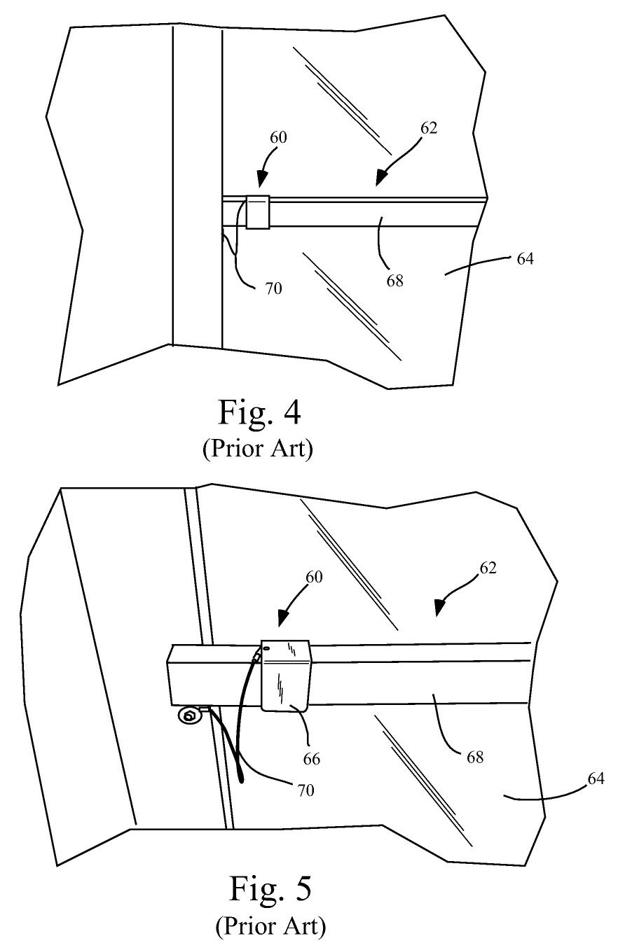

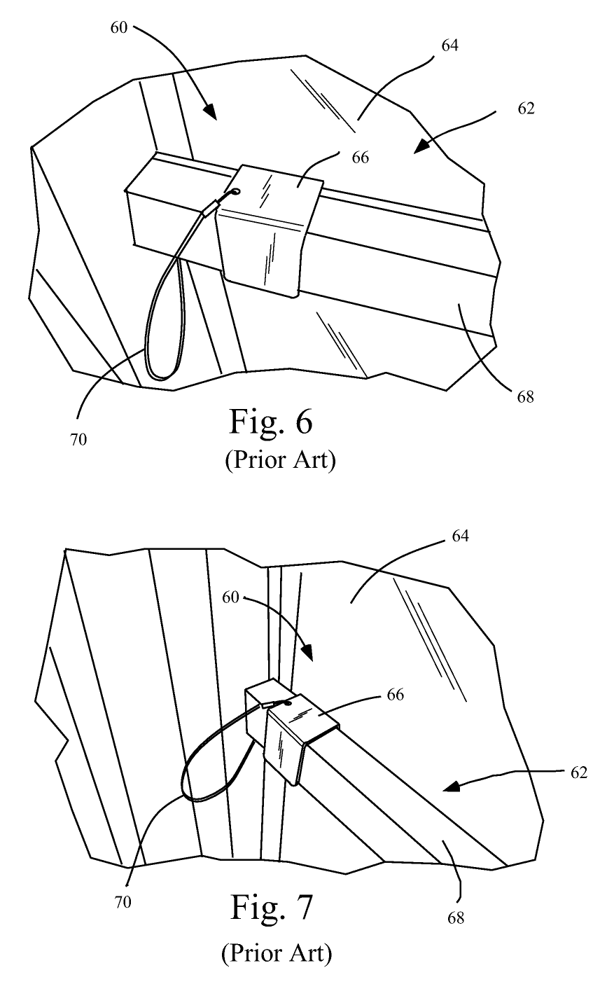

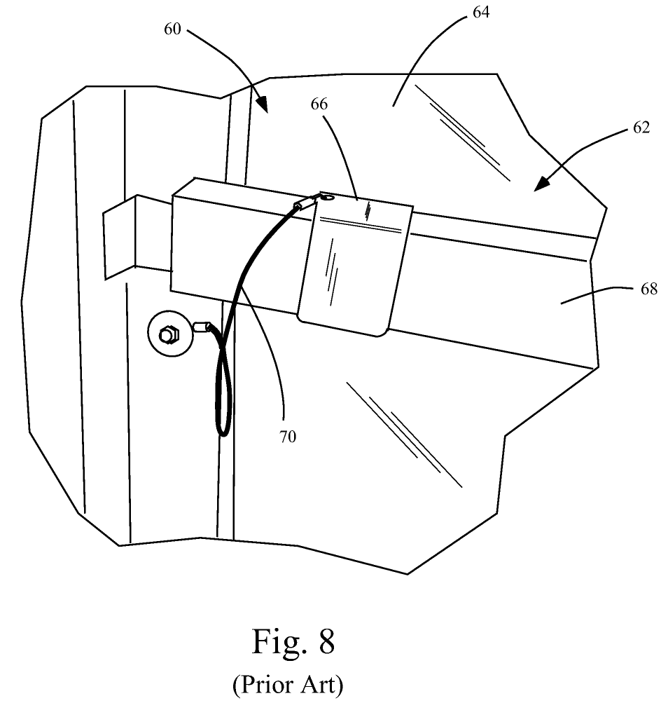

FIGS. 4-8 show a prior art device 60 for controlling an exit device 62 on a door 64. This device 60 includes a simple piece of sheet metal 66 that is folded to compress the push bar 68. The device 60 is attached to door 64 by a metal wire 70. This device is structurally and functionally different from the inventive subject matter and does not provide the advantages of the inventive subject matter, such as adjustability, strength, compression capacity, and a non-interfering, safe attachment to the door.

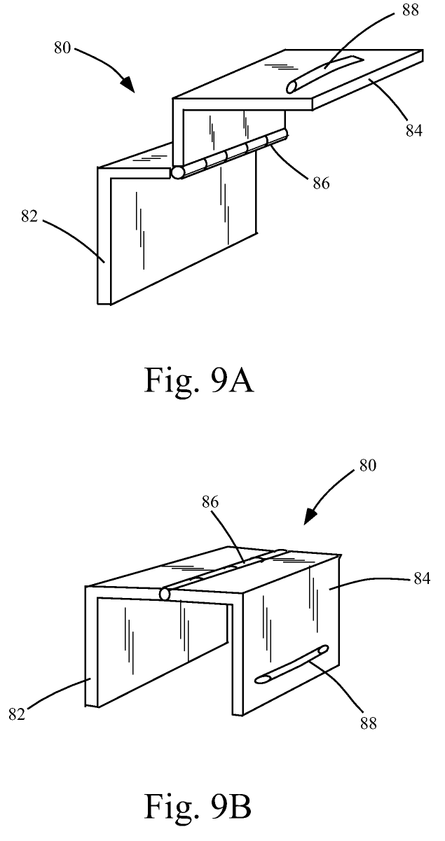

FIGS. 9A and 9B show another possible embodiment of the inventive subject matter, similar to the U-shaped embodiment shown in FIGS. 3A-B, and used in combination with door exit devices that have a gap between the elongated push bar assembly and the door. In this embodiment, the lock-out device is configured to hingeably interact with the operator mechanism. Lock-out device 80 may have an attachment element 82 and an interactive element 84 coupleable to each other with a hinge 86. Attachment element 82 may be coupled to a non-engaging portion of the door, for example at the back of the push bar assembly, i.e., the portion of the bar that does not compress or expand. Hinge 86 allows interactive element 84 to change the condition of the operator mechanism between locked and unlocked condition. For example, hinge 86 allows the interactive element 84 to move from an open position, shown in FIG. 9A, to a closed position, shown in FIG. 9B. The open position of the interactive element is the position whereby the operator mechanism is not engaged and locks the door. In the closed position of the interactive element 84, the interactive element compresses the push bar, holding the door unlocked. For convenience, the interactive element 84 may have a handle 88.

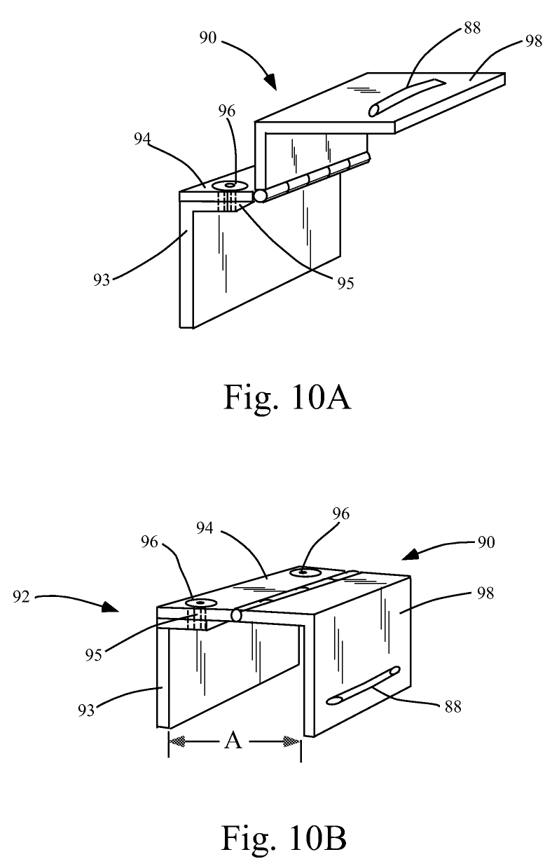

FIGS. 10A and 10B show another possible embodiment of the inventive subject matter, wherein lock-out device 90 is adjustable to accommodate different dimensions of the operator mechanism. Attachment element 92 may have an adjustment mechanism 99, for example two parts which are adjustable, such as plates 93 and 94 that overlap and are provided with slots 95 and adjustment screws 96 to connect two plates 93 and 94. Plates 93 and 94 may be repositioned relative to each other so that interactive element 98 fits over the push bar assembly and keeps the assembly compressed. As shown in FIG. 10B, an adjustment range A, for example ranging between about 3 inches and about 3.5 inches, may be created to accommodate different sizes of push bar systems.

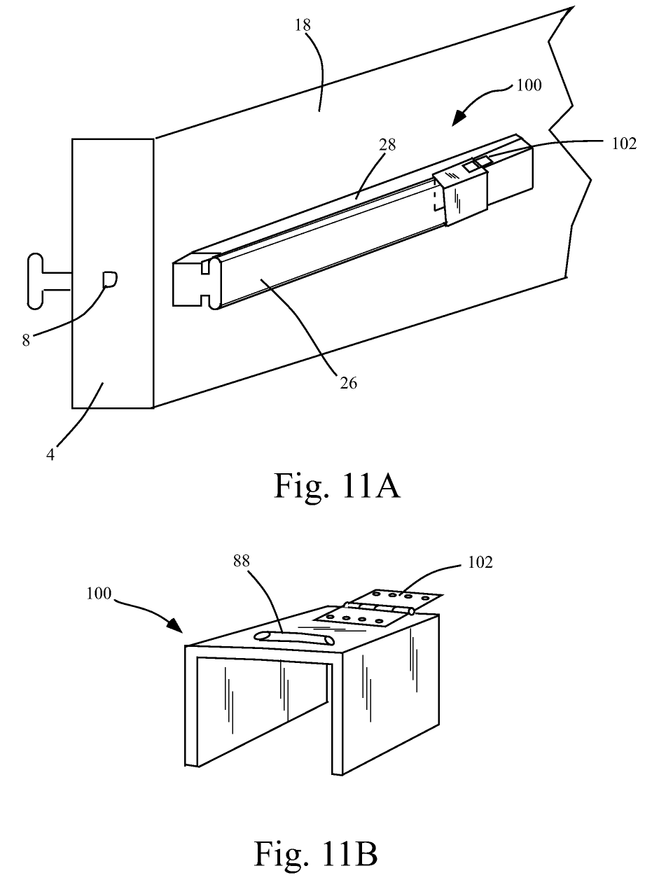

FIGS. 11A and 11B show another possible embodiment to be used with push bar assembly 26. The lock-out device 100 is connected to push bar 26 towards the hinging side of the door. The lockout device 100 is coupled to the exit device push bar 26 with a hinge 102, in an area where hinge 102 may be coupled to a non-engaging portion of the push bar 26.

In the various embodiments, the lock-out device may be tethered to the door and/or the exit device using a cord, cable, chain, string, etc., so that it is not lost or improperly removed.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

Any patent and non-patent literature cited herein is hereby incorporated by references in its entirety for all purposes.

1. A lock-out device for an exit device door operator mechanism, the operator mechanism normally requiring a key to change the condition of the operator mechanism between a locked and unlocked condition, the lock-out device comprising:
a piece of hardware configured to interact with the exit device door operator mechanism, thereby allowing someone on the inside of the door to manually lock the door against entry from the exterior without using the key for the locking mechanism;
a receiver for mounting on a door and for receiving a portion of the lock-out device, enabling the lock-out device to hold the operator mechanism of the door in an unlocked condition; and
wherein the lock-out device is adjustable to fit a range of differently sized exit device door operator mechanisms.

2. The lock-out device of claim 1 wherein the receiver is adjustable allowing the lock-out device to fit a range of differently sized exit door operator mechanisms.

3. The lock-out device of claim 1 wherein the adjustable fit is provided via at least one piece of material adapted to fit between the receiver and inside surface of the door so that the receiver will hold the piece of hardware keeping the operator mechanism of the door in an unlocked condition.

4. The lock-out device of claim 3 wherein the piece of material comprises a metal shim.

5. The lock-out device of claim 1 wherein the lock-out device engages and holds a push bar assembly in a compressed position, and removal of the lock-out device allows the push bar assembly to be uncompressed, causing a door strike to engage its recess, locking the door.

6. The lock-out device of claim 5, further comprising at least one shim to built-up the receiver so that the lock-out device will hold the push bar assembly in a compressed position.

7. The lock-out device of claim 1 wherein the lock-out device is configured to maintain a bar handle in a depressed position, and removal of the lock-out device allows the door to return to an outward position that causes a door strike to engage its recess, locking the door.

8. The lock-out device of claim 7 wherein the bar handle is a hinging bar handle.

9. The lock-out device of claim 8 wherein the adjustable fit is provided via two or more shims mounted on the receiver so that a slot is created between the shims that will hold a portion of the lock-out device.

10. A lock-out device for an exit device door operator mechanism, the operator mechanism normally requiring a key to change the condition of the operator mechanism between a locked and unlocked condition, the lock-out device comprising:
an attachment element, the attachment element coupleable to a non-engaging portion of the door or operator mechanism;
an interactive element, the interactive element adapted to hold the operator mechanism in the unlocked condition;
a hinge connecting the attachment element with the interactive element; and
wherein the hinge allows the interactive element to change from a first position in which the interactive element is disengaged from the operator mechanism, to a second position in which the interactive element engages the operator mechanism and keeps the door operator mechanism in unlocked condition.

11. The lock-out device of claim 10 further comprising an adjustment mechanism allowing the lock-out device to adjust to a range of differently sized door operator mechanisms.

12. The lock-out device of claim 11 wherein the adjustment mechanism comprises at least two plates that are adjustable relative to each other so that in the second position the interactive element holds the operator mechanism in the unlocked condition.

13. The lock-out device of claim 12 wherein the plates are adjustable over an adjustment range to accommodate different sizes of push bar assemblies.

14. The lock-out device of claim 10 further comprising a handle.

15. The lock-out device of claim 1 further comprising an exit door device, in a kit with the lock-out device.

16. The lock-out device of claim 10 further comprising an exit door device, in a kit with the lock-out device.

17. The lock-out device of claim 1, further comprising at least two shims in a kit with the lock-out device.

18. The lock-out device of claim 15 wherein the exit door device is a compressable bar handle.

19. The lock-out device of claim 15 wherein the exit door device is a hingeable bar handle.

20. A method of installing lock-out devices on exit device door operator mechanism in an establishment consisting of a building or complex of buildings having multiple doors provided with exit door operator mechanisms, the operator mechanism normally requiring a key to change the condition of the operator mechanism between a locked and unlocked condition, the method comprising:
configuring a piece of hardware to interact with the exit device door operator mechanism, thereby allowing someone on the inside of the door to manually lock the door against entry from the exterior without using the key for the locking mechanism;
mounting a receiver on a door for receiving a portion of the lock-out device, enabling the lock-out device to hold the operator mechanism of the door in an unlocked condition; and
adjusting the lock-out device to fit a range of differently sized exit device door operator mechanisms.
